(19) United States
(12) Patent Application Publication
(10) Pub. No.: US 2012/0176318 A1
(43) Pub. Date: Jul. 12, 2012

(54) FOLDABLE MOUSE

(75) Inventor: Chi-Sheng HUANG, Taipei (TW)

(73) Assignee: CHICONY ELECTRONIC CO., LTD., New Taipei City (TW)

(21) Appl. No.: 13/088,888

(22) Filed: Apr. 18, 2011

(30) Foreign Application Priority Data
Jan. 6, 2011 (TW) 100200239

(51) Int. Cl. G06F 3/033

(52) U.S. Cl. 345/163

(57) ABSTRACT

The present invention discloses a foldable mouse comprising an upper shell, a lower shell, a pivotal mechanism pivotally connecting said upper shell and said lower shell and enabling the horizontal and pivotal rotation of said upper shell with respect to said lower shell, and a cover plate covering on said upper shell.

### BACKGROUND OF THE INVENTION

1. Field of the Invention

The present invention relates to a mouse device, and more particularly, to a foldable mouse device.

2. Description of the Related Art

The notebook today is getting thinner and thinner. A lot of users can not habituate themselves to the specific pointing device on notebook (ex. touch pad) such that they usually prepare external mouse device to use with notebook. For this reason, various type of slim mouse came with the tide of fashion. The slim mouse is generally characterized by its good portability and lightweight as well as the excellent hand feel and handleability that may be provided by conventional mouse device for desktop computer. Most approaches for the slim mouse in industry today are proceeded from the mechanical design to provide the slim mouse with the above-mentioned characteristics.

One type of slim mouse design is disclosed in Taiwanese granted invention No. I327287. The rear shell of said slim mouse may be pivotally rotated via a connecting element to enable the mouse being transformed into an actuation form with ergonomic holding angle from original, flat appearance. Although said mouse device may transform between the flat form and actuation form, such transformation action can only provide the change in shape of mouse. The actual space been saved is limited.

Accordingly, it is needed in industry a novel foldable design for slim mouse to achieve the efficacy of saving more space.

### SUMMARY OF THE INVENTION

In the light of the development of mouse and notebook today, one object of present invention is to provide a novel, foldable mouse device which is provided with a foldable body for the mouse to be collapsed into a compact folded form when unused, and said foldable body may be expanded into an ergonomic actuation form when in use. The present invention provides a novel mouse design with both good portability and modern styles.

The foldable mouse of present invention is comprised of: an upper shell with an upper free end and an upper pivotal end having an opening formed thereon, a lower shell with a lower pivotal end and a lower free end having a plurality of buttons placed thereon, a pivotal mechanism placed in the opening of said upper shell to pivotally connect the upper pivotal end of said upper shell with the lower pivotal end of said lower shell and enable the pivotal and horizontal rotation of said upper shell with respect to said lower shell, and a cover plate covering over said opening of the upper shell.

In other aspect of the present invention, an power switch may be optionally positioned in the mouse to enable power ON/OFF switch between the folded state and expanded state of the mouse. This is a novel mouse design with integrated mechanical structure and electronic technology.

Many other aspects, objects, features and advantages of present invention may become readily apparent to those of skill in the art upon reviewing the detailed embodiments when taken in conjunction with accompanying drawings and claims.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1A is a schematic side view of the foldable mouse under folded state in accordance with the embodiment of present invention;

FIG. 1B is a schematic top view of the foldable mouse under folded state in accordance with the embodiment of present invention;

FIG. 2A is a schematic side view of the foldable mouse under expanded state in accordance with the embodiment of present invention;

FIG. 2B is a schematic top view of the foldable mouse under expanded state in accordance with the embodiment of present invention;

FIG. 3 is a schematic top view showing the pivotal rotation of upper shell with respect to lower shell in accordance with an embodiment of the present invention;

FIG. 4 is an elevation view of a micro switch in accordance with the embodiment of the present invention; and

FIG. 5 is a schematic top view of a mouse with micro switch of FIG. 4 mounted thereon. It is illustrated in the figure that the upper shell is pivotally rotated on the lower shell.

### DETAILED DESCRIPTION OF THE PREFERRED EMBODIMENTS

Various aspects of present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements described as being on the “lower” side of other elements would then be oriented on the “upper” side of the other elements. The term “lower” can therefore encompass both an orientation of “lower” and “upper,” depending of the particular orientation of the apparatus. Similarly, if an apparatus in the drawing is turned over, elements described as “below” or “beneath” other elements would then be oriented “above” the other elements. The terms “below” or “beneath” can therefore encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

The foldable mouse of present invention may be transformed between a folded state and an expanded state via the pivotal mechanism to achieve better portability as well as to give the impression of modern style.

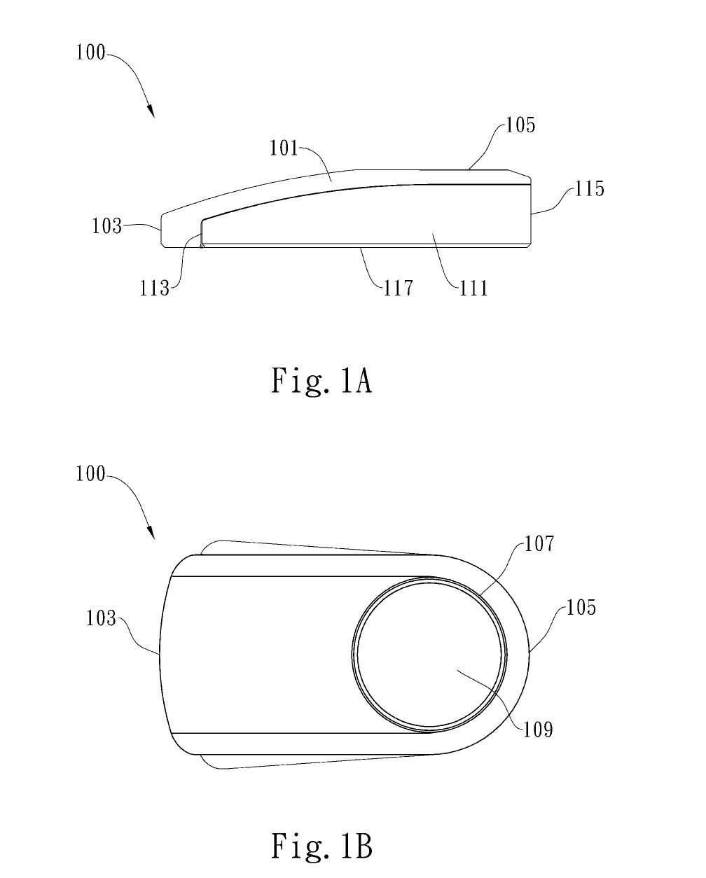

First, please refer to FIG. 1A and FIG. 1B which illustrates respectively the side view and top view of the foldable mouse under folded state in accordance with the embodiment of present invention. As shown in the figure, the foldable mouse 100 of present invention is primarily comprised of an upper shell 101 and a lower shell 111. Said lower shell 111 is an elongated structure served as the base of mouse 100 to provide structural support and necessary receiving space for the components of mouse 100 (ex. circuit board, scroll wheel, wireless module and/or battery). The front end of lower shell 111 is a lower free end 113 which may be optionally provided with at least one control interface, such as a plurality of buttons and scroll element (ex. scroll wheel and touch wheel). The back end of lower shell 111 is a lower pivotal end 115 where said lower shell 111 is pivotally connected to said upper shell 101. The thickness of lower shell 111 is getting thinner from lower pivotal end 115 to lower free end 113 in order to form a mouse with ergonomic shape.

Refer again to FIG. 1A and FIG. 1B, the upper shell 101 is an elongated slim cover served as the palm rest portion of mouse 100 for supporting user's palm when in use. The shape of upper shell 101 is dimensioned for conforming to the upper contour of lower shell 111. By such compact design, the upper shell 101 is overlapping on the upper surface of lower shell 111 under folded state for shielding and protecting the control interfaces (ex. buttons and scroll mechanism) placed on lower shell 111. The front end of upper shell 101 is an upper free end 103 extending along the contour of lower shell 111 to the outer edge of lower free end 113 and flushing with the bottom surface of said lower shell 111. The back end of upper shell 101 is an upper pivotal end 105 where said upper shell 101 is pivotally connected with said lower shell 111.

As shown in FIG. 1B, a circular opening 107 is formed adjacent to the upper pivotal end 105 of upper shell 101. A pivotal mechanism (not shown) is positioned inside said opening 107 to pivotally connect the upper pivotal end 105 of upper shell 101 to the lower pivotal end 115 of lower shell 111 and enable the pivotally and horizontally rotating of said upper shell 101 with respect to said lower shell 111. Such rotation mechanism will be further described in the embodiment below. A round cover plate 109 may be optionally covered over the opening 107 of said upper shell 101 to shield the opening and all of the components placed therein, such as the pivotal mechanism and power switch element. The relevant details will be further described in following embodiment.

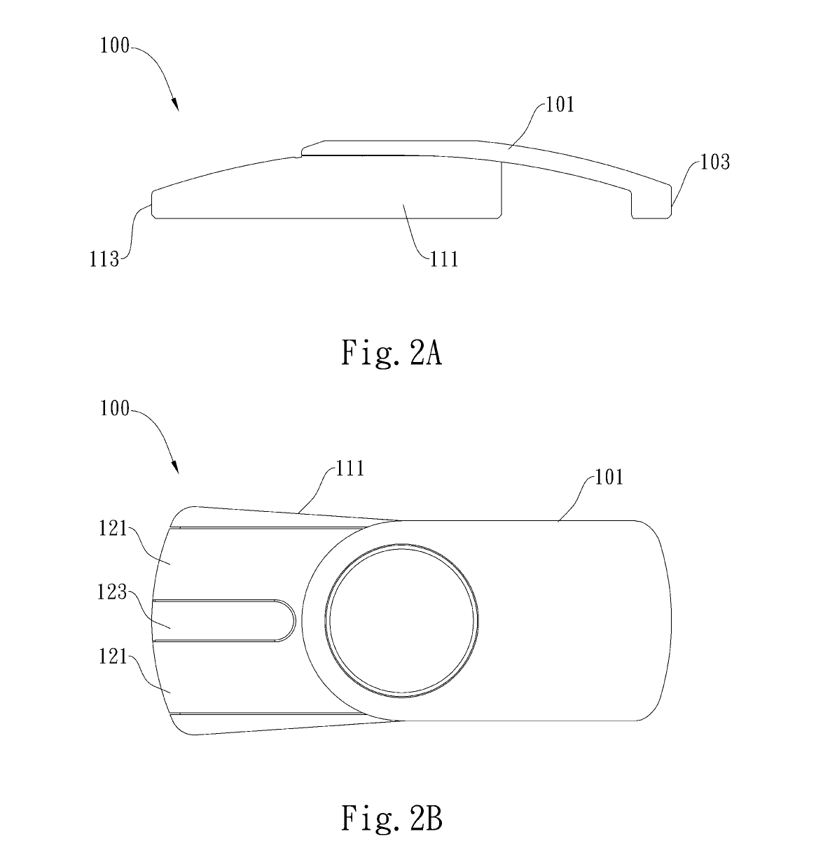

Refer now to FIG. 2A and FIG. 2B which illustrate respectively the side view and top view of the foldable mouse under expanded state in accordance with the embodiment of present invention. As shown in the figure, the upper shell 101 once overlapping on the lower shell 111 under folded state is horizontally and pivotally rotated about 180 degree to an expanded state where the upper free end 103 is positioned opposite to the lower free end 113 of lower shell 111. After the rotation of said upper shell 101, button 121 and scroll mechanism 123 placed on lower shell 111 beneath the upper shell 101 will be exposed. Under this state, the mouse device is expanded to an elongated form with its longitudinal length longer than the one under folded state. The length of mouse 100 under expanded state is dimensioned for the user to rest his palm on the upper shell 101 and easily perform the click action on the lower shell 111 via fingers. In addition of conforming to the contour of lower shell 111, as shown in FIG. 2A, the shape of upper shell 101 is dimensioned such that the upper free end 103 of upper shell 101 is extended and rested on the moving plane behind mouse 100 and is flushed with the bottom surface of said lower shell 111 after being rotated to the expanded position. This design may provide structural support for the mouse to move stably on the moving plane.

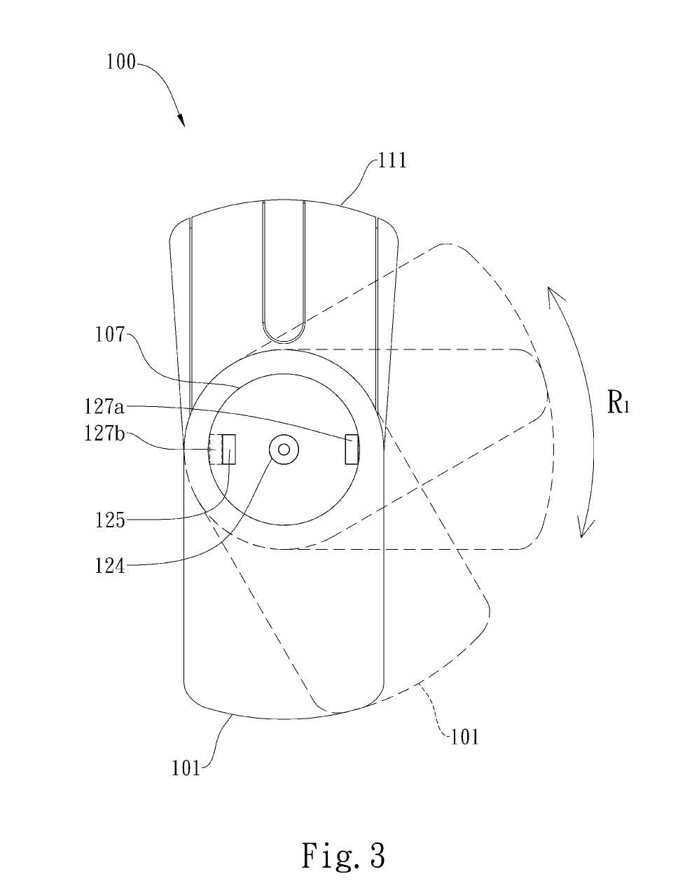

Refer now to FIG. 3 which illustrates the schematic top view of upper shell 101 being pivotally rotated on lower shell 111. The cover plate 109 shown in previous figure is omitted in this figure in order to expose the components placed inside the opening 107. As described in the embodiment above, a pivotal mechanism 124 is positioned in said opening 107 of upper shell 101 to pivotally connect said upper shell 101 with said lower shell 111. The pivotal mechanism 124 may be a pivot element. The upper shell 101 in folded state may be pivotally rotated about 180 degree in the direction parallel to the moving plane of mouse 100 (as arrow R₁ shown in the figure) to the expanded position. Furthermore, a power switch may be further provided in said opening 107 for the purpose of activating or deactivating the mouse via the pivotal rotation of said upper shell 101. As shown in FIG. 3, a contact piece 125 is placed on the portion of lower shell 111 in the opening 107 of upper shell 101. Said contact piece 125 is coupled to the circuit board inside the mouse and doesn't move along with the rotation action of upper shell 101. A corresponding contact piece 127a is placed on the sidewall of opening 107 of upper shell 101. Said contact piece 127a is coupled with the power module inside the mouse and is positioned at right side of mouse under folded state. On the other hand, said contact piece 127a is positioned at left side of mouse (i.e. 127b shown by the dash portion in the figure) when the upper shell 101 is pivotally rotated about 180 degree to the expanded state. At this position, the contact piece 125 on lower shell 111 is electrically connected to the contact piece 127b on upper shell 101 such that the power is turned ON and the mouse is actuated. In this way, the above-mentioned switch mechanism may enable the mouse to be turned OFF under folded state and to be turned ON under expanded state. This mechanism is very useful in the design of wireless mouse that the internal battery is inevitably utilized. The user may unfold the mouse to expanded state before use. This action can simultaneously actuate the mouse.

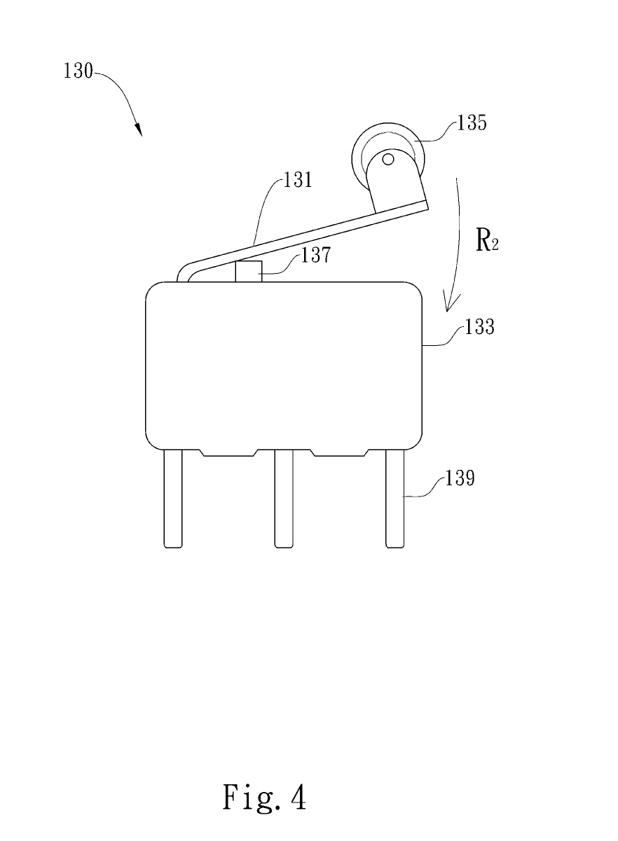

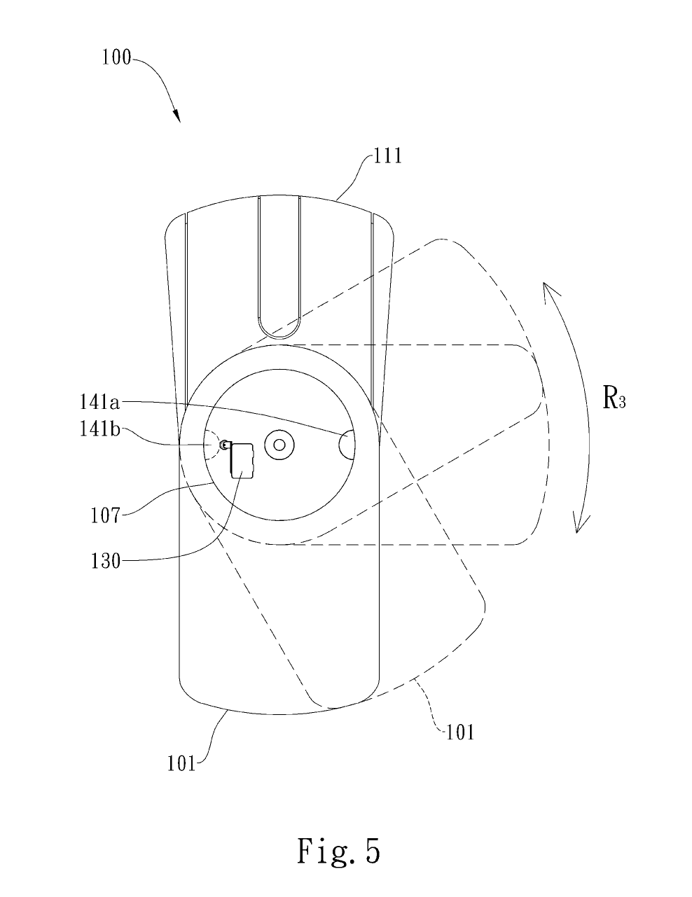

The power ON/OFF switch for the mouse in above embodiment of present invention is achieved by the rotating action to electrically connecting the contact pieces. However, in another embodiment of present invention, this function may be achieved by utilizing other devices. Refer now to FIG. 4 and FIG. 5 which show respectively the elevation view of micro switch 130 for performing power ON/OFF switch and the top view of mouse 100 with said micro switch 130 placed therein. It is illustrated in FIG. 5 that the upper shell 101 is pivotally rotated on lower shell 111. As shown in FIG. 4, the micro switch 130 is provided with a swing arm 131 extending slantingly from one side of the main body 133 to the other side. A rotatable contact element 135 is placed on one end of swing arm 131. The middle portion of said swing arm 131 is supported by a switch element 137 positioned on the top side of the main body 133. In one implementation, the contact element 135 on one end of swing arm 131 will be propelled by a predetermined portion of mouse (ex. a protrusion) via the relative movement (ex. rotation, displacement) of the components so that the swing arm 131 will be swayed toward the main body 133, as shown by the arrow R₂ in the figure. This movement will cause the middle portion of swing arm 131 to press upon the switch element 137 therebeneath and result in the power ON/OFF switch. A plurality of pins 139 are placed on the bottom of micro switch 130 to electrically connect with the with the components such as circuit board. This may enable the switch element 137 to perform power ON/OFF switch to the circuit board in mouse 100.

Please refer now to FIG. 5. The micro switch 130 is mounted on the top surface of lower shell 111 in the opening 107 of upper shell 101. Therefore, said micro switch 130 will not move along with the rotation of upper shell 101. A protrusion 141a is formed on the inner sidewall of opening 107 of the upper shell 101. As shown in the figure, said protrusion 141a is positioned such that it is located at the right side of mouse under the folded state which the upper shell 101 is covering over the lower shell. When the upper shell 101 is rotated 180 degree to the opposite expanded position (as the dash line and arrow R₃ shown in the figure), said protrusion 141a is shifted to left side of mouse 100, as shown by 141b in the figure. The protrusion 141a is dimensioned to be press against the contact element 135 of stationary micro switch 130 placed on the lower shell 111 during the rotation movement. This mechanism may cause the switch element 137 to switch and then achieve the function of power ON/OFF for the circuit board.

In addition to the above-mentioned components, a plurality of positioning mechanism (not shown) may be optionally placed or formed at the interface between upper shell 101 and lower shell 111 to facilitate the transformation of mouse 100 between folded state and expanded state. Said positioning mechanism may be corresponding magnet pair or snap-fit feature provided at the interface between upper shell 101 and lower shell 111. By magnetic force or snap-fit of positioning mechanism, the two shells 101 and 111 may be fixed at predetermined orientation under folded state or expanded state. This may help user to maintain the mouse 100 in desired form.

The illustrations of the embodiments and drawings described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, the foldable mouse of present invention may be utilized with the specification of wired transmission (ex. PS/2 or USB) or wireless transmission (ex. 2.4G or bluetooth). In the condition of wired transmission, the battery module inside the mouse may be lithium battery or AAA battery to provide power. Furthermore, an optical sensor may be optionally placed on the lower shell of mouse to sense the movement of mouse. Said optical sensor may be infrared sensor or laser sensor. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

What is claimed is:

1. A foldable mouse, comprising:
an upper shell with an upper free end and an upper pivotal end, in which said upper pivotal has an opening;
a lower shell with a lower free end and a lower pivotal end; and
a pivotal mechanism placed in the opening of said upper shell to pivotally connect the upper pivotal end of said upper shell with the lower pivotal end of said lower shell and enable said upper shell to rotate horizontally and pivotally with respect to said lower shell.

2. The foldable mouse according to claim 1, wherein said upper shell is pivotally rotated to a folded position at which said upper free end is overlapping on said lower free end.

3. The foldable mouse according to claim 1, wherein said upper shell is pivotally rotated to an expanded position at which said upper free end is opposite to said lower free end.

4. The foldable mouse according to claim 3, wherein the shape of said upper shell is designed such that when said upper shell is at said expanded position, the upper free end of said upper shell extends to and rests on a moving plane behind said foldable mouse for providing structural support.

5. The foldable mouse according to claim 2, further comprising a power switch placed at the interface between said upper shell and said lower shell, said power switch is turned OFF when the upper shell is at the folded position.

6. The foldable mouse according to claim 3, further comprising a power switch placed at the interface between said upper shell and said lower shell, said power switch is turned ON when the upper shell is at said expanded position.

7. The foldable mouse according to claim 6, wherein said power switch comprises contact pieces placed respectively on said upper shell and said lower shell, and said contact pieces are electrically connected to each other at said expanded position.

8. The foldable mouse according to claim 6, wherein said power switch comprises a protrusion and a micro switch placed respectively on said upper shell and said lower shell, said protrusion is propelled against said micro switch at said expanded position to achieve the ON/OFF switch of said micro switch.

9. The foldable mouse according to claim 2, further comprising a plurality of positioning mechanism for fixing said upper shell and lower shell at said folded position.

10. The foldable mouse according to claim 3, further comprising a plurality of positioning mechanism for fixing said upper shell and lower shell at said expanded position.

11. The foldable mouse according to claim 9, wherein said plurality of positioning mechanism are magnet pair or snap-fit feature placed respectively on said upper shell and said lower shell.

12. The foldable mouse according to claim 10, wherein said plurality of positioning mechanism are magnet pair or snap-fit feature placed respectively on said upper shell and said lower shell.

13. The foldable mouse according to claim 1, further comprising a cover plate covering on the opening of said upper shell.

14. The foldable mouse according to claim 1, further comprising at least one control interface provided on said lower shell.

15. The foldable mouse according to claim 14, wherein said control interface is button or scroll mechanism.

16. The foldable mouse according to claim 14, wherein said control interface is touch mechanism.

17. The foldable mouse according to claim 1, further comprising an optical sensor provided on said lower shell, and said optical sensor is infrared sensor or laser sensor.

18. The foldable mouse according to claim 1, further comprising a battery module provided in said lower shell, and said battery module is lithium battery or AAA battery.

19. The foldable mouse according to claim 1, wherein said mouse is wired mouse or wireless mouse whose wireless transmission specification is 2.4G or Bluetooth.
